(19) United States
(12) Patent Application Publication
(10) Pub. No.: US 2024/0134732 A1
(43) Pub. Date: Apr. 25, 2024

(54) Cause Alert and Clear Alert Correlation

(71) Applicant: Dell Products, L.P., Round Rock, TX (US)

(72) Inventors: Pushkala Iyer, Round Rock, TX (US); Kevin Noreen, Round Rock, TX (US); Alaric Silveira, Austin, TX (US); Manoj Malhotra, Austin, TX (US)

(21) Appl. No.: 17/969,664

(22) Filed: Oct. 18, 2022

(51) Int. Cl. G06F 11/07

(52) U.S. Cl. CPC G06F 11/0769; G06F 11/0793

(57) ABSTRACT

Cause alert and clear alert correlation is disclosed. The presently disclosed subject matter discloses generating a clear alert that can identify a related existing cause alert based on determining an updated hardware, software, and/or environmental state of a device, device role, etc. The clear alert can be positively correlated to the existing cause alert based on the identification of the cause alert comprised in the clear alert. The correlation of the cause and clear alert can be employed to alter a resolution event. Further, the correlation of the cause and clear alert can be employed to alter alert information that can be accessed by a user, such as an admin, etc., e.g., a cause alert can be marked as resolved after correlation to the clear alert, which can reduce extraneous alert information presented to an admin, for example, in an alert log, summary alert log, system health dashboard, etc.

### BACKGROUND

Conventional systems management solutions can propagate alerts received from monitored devices, which alerts can be displayed to administrative users (admins) in an alert log view or an alert summary view. A common problem with conventional presentation of alerts in a log or summary view is that it can be unclear to admins if a condition corresponding to an alert has been resolved. In this regard, a first alert to a problem with a monitored device can be followed at a later time with a second alert that the problem with the monitored device has been cleared, but failure to effectively correlate the first and second alerts can result in the first alert persisting despite the problem having already been cleared, e.g., there can be a failure to clear the first alert upon receipt of the second alert, which failure can stem from lack of effective correlation between the first and second alerts. The conventional systems management solutions can further become increasingly complex where there can be multiple alert conditions contributing to an evaluation of an overall health of a system. In an example, multiple cause alerts, corresponding to one or more problems of one or more monitored devices, and multiple clear alerts, corresponding to resolution of one or more the problems of the one or more monitored devices can correspond to an overall system health condition. Where cause and clear alerts are poorly correlated, it can be nearly impossible for an admin to appreciate an actual health of the system. The problem can be exacerbated where there can be significant elapsed time between a cause alert and a clear alert, which can force an admin to review correspondingly long alert logs to try to understand if a cause alert has actually been resolved and should be considered cleared. It is important to know which problems are still truly outstanding for an admin to appreciate actual system health conditions. The ability to immediately know what problems exist with which devices of a system is imperative for effective systems monitoring and problem resolution management, and conventional systems fail to provide such information in a meaningful manner.

### BRIEF DESCRIPTION OF DRAWINGS

FIG. 1 is an illustration of an example embodiment that can facilitate system-side cause alert and clear alert correlation, in accordance with aspects of the subject disclosure.

FIG. 2 is an illustration of one example embodiment that can enable edge-side cause alert and clear alert correlation, in accordance with aspects of the subject disclosure.

FIG. 3 is an illustration of an example embodiment that can support system-side notification of, and responses to, a system alert based on cause alert and clear alert correlation, in accordance with aspects of the subject disclosure.

FIG. 4 is an illustration of an example embodiment that can enable tuple generation facilitating cause alert and clear alert correlation, in accordance with aspects of the subject disclosure.

FIG. 5 is an illustration of an example embodiment that can facilitate cause alert and clear alert correlation corresponding to one or more edge zones, in accordance with aspects of the subject disclosure.

FIG. 6 is an illustration of an example method facilitating cause alert and clear alert correlation, in accordance with aspects of the subject disclosure.

FIG. 7 is an illustration of an example method enabling tuple generation facilitating cause alert and clear alert correlation, in accordance with aspects of the subject disclosure.

FIG. 8 is an illustration of an example method facilitating responding to a system alert based on cause alert and clear alert correlation, in accordance with aspects of the subject disclosure.

FIG. 9 depicts an example schematic block diagram of a computing environment with which an embodiment of the disclosed subject matter can interact, in accordance with aspects of the subject disclosure.

FIG. 10 illustrates an example block diagram of a computing system operable to execute the disclosed systems and methods in accordance with an embodiment of the subject disclosure.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Generally, conventional systems management solutions can receive cause alerts corresponding to monitored devices. Cause alerts can be indicative of device problems, failures, etc. Cause alerts can be displayed to admins, e.g., in an alert log view, an alert summary view, etc., to aid the admin in understanding a health condition of the system comprising the device. As an example, an admin can monitor a data center system that can comprise multiple cabinets that can each comprise multiple servers, that can each comprise multiple devices such as memory modules, power supplies, cooling fans, processors, etc., that can be monitored by one or more device monitoring components (DMCs). An example DMC can be an application executing on a processor of a server of the example data center, which example DMC can monitor devices of that server. In this example, a failing power supply of an example server can be monitored by a DMC, which can send an alert to a system management component corresponding to management of the example data center, which can result in presenting a cause alert being presented to an admin, e.g., ‘warning—power supply of example server not nominal’, etc. This cause alert can be evaluated, for example by the admin, etc., and can be a cause of some resolving activity, such as ordering a replacement power supply, initiating a repair, failing over to another power supply, etc. In this example, after some time, the failing power supply can be replaced, resolving the problem and triggering a clear alert to be sent to the systems management component. However, in this example, a conventional systems management solution may fail to correlate the clear alert with the cause alert, which can result in the cause alert persisting. The persisting cause alert can cause confusion over the actual health of the example data center.

This example can demonstrate a common problem with conventional presentation of alerts, e.g., poor correlation between cause and clear alerts can result in situations where it can be unclear to admins if a condition corresponding to an alert has actually been resolved or is still outstanding. The conventional systems management solutions can further become increasingly complex where there can be multiple alert conditions contributing to an evaluation of an overall health of a system. Returning to the preceding example, where two cooling fans of the example server become temporarily blocked by an object placed in front of an air intake, the DMC can generate two cause alerts, one for each fan that has ‘failed’. Where the blocking object in this example is shifted in a way that allows more air intake and now only blocks one of the two fans in this example, the DMC can determine that one of the fans has returned to normal operation and can send one corresponding clear alert. However, this clear alert can be difficult for an admin to understand in the context of already having logged the two example cause alerts, e.g., it can be unclear which fan has returned to nominal operation, etc. Where cause and clear alerts are poorly correlated, it can be nearly impossible for an admin to appreciate an actual health of the system of even modest complexity. Moreover, as noted previously, the problem of poor correlation of cause and clear alerts can be exacerbated where there can be significant elapsed time between a cause alert and a clear alert, which can force an admin to review correspondingly long alert logs to try to understand if a cause alert has actually been resolved and should be considered cleared. It can be critically important for an admin to quickly be able to understand actual system health and to know which problems are still truly outstanding so that the admin can be effective in managing a system. Conventional systems fail to provide such information in a meaningful manner.

The difficulty for an admin to quickly understand a system health condition can further relate to ticketing systems problems. A ticket generation system can be paired with a systems management application, so that trouble tickets for problematic situations can be automatically created. In an example, a ticketing system can open multiple support trouble tickets for parts replacement following some hardware cause alerts from a server, e.g., fan not functional, dual inline memory module (DIMM) failure, etc. In this example, if a fan problem is due to some mechanical obstruction and the obstruction is removed causing the fan to return to normal operation again, which can trigger a clear alert, without correlating the fan normal operation event to the fan dysfunctional event, the example ticketing system can be ignorant of the fan no longer needing to be replaced and can fail to automatically update or cancel the example support ticket that was created for parts dispatch of a fan responsive to the example earlier cause alert. Again, the lack of effective correlation between cause and clear alerts for conventional systems management solutions can be understood to be problematic.

The presently disclosed subject matter can facilitate alert correlation. Alert correlation can be facilitated by including identifiers and metadata in cause alerts and clear alerts, allowing for correlation of cause and clear alerts based on the identifiers and metadata. An identifier can be a unique device identifier, a device role identifier, or other identifier. As an example, an identifier can identify a failing fan by the fan serial number unique to that fan. As another example, an identifier can identify a failing fan by the role that fan occupies, such as being a ‘third fan of a server’, where the ‘third fan’ can be distinguished from other fans of the example server. In this example, the unique role of the fan, e.g., as the ‘third fan’, can provide sufficient unique identification of the fan for correlation to other alerts and/or resolution of a problem with that fan, even where the specific identity of the fan, e.g., a serial number, etc., is not employed. As an analogous example, a car with license plate ‘ABC-123’ can be illegally parked in reserved parking space #15 of a parking lot. A towing company can be notified to tow the car. Identifying the car to the towing company can be “the car in reserved parking space #15” and/or “the car with license plate ‘ABC-123’”, to allow the towing company to remove the correct car. It is noted that any car parked in space #15 will be towable because, in this analogy, any car in the reserved spot is equally towable. In this analogy, the person calling the towing company doesn't need to have specific information about the car in the reserved parking spot. Similarly, in the presently disclosed subject matter, device roles can be used in cause and clear alerts without needing to gather globally unique device identifiers, although globally unique device identifiers can be used where available or beneficial.

Metadata of the presently disclosed subject matter can comprise alert identifiers, e.g., a cause alert identifier (causeMsgID), a clear alert identifier (clearMsgID), a current system health value after a clear alert (sysHealthCond), a timestamp of a preceding alert, for example a timestamp corresponding to a first corresponding cause alert (firstCauseTS), etc., or other metadata. A tuple, e.g., an n-tuple, can be generated that can comprise metadata relevant to an alert, for example a clear alert can comprise a device role identifier and metadata indicating a corresponding cause alert to be cleared and other metadata indicating system health after the resolving event triggering generation of this example clear alert.

The disclosed subject matter can facilitate correlation between cause and clear alerts that can enable rapid resolution of related alerts, e.g., clearing of cause alerts that can be presented to an admin, such as in an alert summary view. This can allow the admin to have an immediate appreciation of system health conditions and support meaningful resolution of a problem among devices comprising a system being managed. In embodiments, the use of cause and clear alerts that facilitate correlation can be extended from a central admin system, related to managing edge systems, e.g., 1×M management, to edge admin systems, e.g., 1×1 management. Accordingly, a site admin can have a localized understanding of the health of devices at the site being monitored and a systems admin at a centralized location managing multiple sites can also have a more global understanding of the health of devices across the multiple sites. It is further noted that, in embodiments, hardware alerts, software alerts, environmental alerts, etc., or combinations thereof can be monitored, and corresponding cause and clear alerts can be correlated. Examples can include, but are expressly not limited to, a thermal condition in a server cabinet can trigger a cause alert and/or a clear alert, an application in execution at a server being monitored can go out of warranty triggering a cause alert that can be resolved by the client purchasing an extended warranty that can trigger a clear alert, a device can be moved from an initial installed location triggering a cause alert that can be cured by an admin updating the allowed location of the device and triggering a clear alert, or nearly any other monitorable condition of devices of a system.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

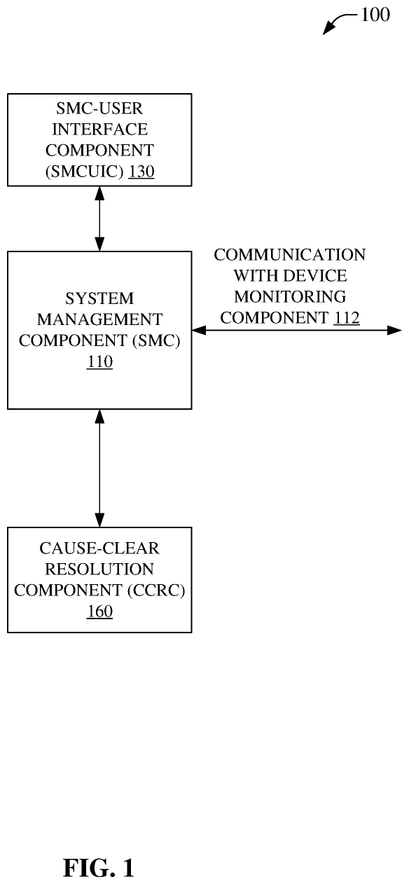

FIG. 1 is an illustration of a system 100, which can facilitate system-side cause alert and clear alert correlation, in accordance with one or more embodiments of the subject disclosure. System 100 can comprise system management component (SMC) 110 that can communicate with a device monitoring component (DMC), e.g., via communication with DMC 112. SMC 110 can receive an alert, e.g., a cause alert, a clear alert, etc. A cause alert can indicate a problem, fault, condition, etc., of a device, device environment, etc. As examples, a cause alert can indicate a failure of a power supply device, a memory module, a fan, a connection, etc., can indicate a temperature of a device environment, incursion of water into a device environment, etc., can indicate condition of a device, such as a warranty state, a spin speed of a hard drive, a software fault, etc., or other problem, fault, condition, etc., of a device, device environment, etc.

In some embodiments, a cause alert can indicate an alert identifier, for example cause alert 1, cause alert 2, . . . , cause alert n, etc. In some embodiments, a cause alert can indicate a device or device role identifier, for example, device serial number XYZ, device in position number four, etc. In some embodiments, a cause alert can indicate a problem, fault, etc., associated with the cause alert, for example, ‘fan not spinning,’ ‘DIMM failure,’ ‘power supply voltage low (or a specific voltage),’ etc. In some embodiments, a cause alert can indicate a timestamp. In some embodiments, a cause alert can indicate an alert level, for example, ‘severity is warning,’ ‘severity is critical,’ etc. Accordingly, as examples, a cause alert can be: Fan001_1 (fan 1 spinning low), severity is warning at timestamp TS1′ where Fan001_1 indicates a first fan alert for fan #1, where fan #1 is spinning low, which is associated with a warning-level severity, at time TS1; Fan002_6 (fan 6 not spinning), severity is warning at timestamp TS2′ Fan002_6 indicates a second fan alert for fan #6, where fan #6 is not spinning, which is associated with a warning-level severity, at time TS2; TSU001_1 (PSU 1 faulty), severity is critical at timestamp TS3′ PSU001_1 indicates a first power supply unit (PSU) alert for PSU #1, where PSU #1 is determined to be faulty, which is associated with a critical-level severity, at time TS3; etc. In general, a cause alert can be of the form [alert number_device/role identifier, event information, severity indicator, timestamp], for example [causeMsgID, event information, sysHealthCond, firstCauseTS].

In an example server, which can comprise six fans and two PSUs, a DMC can determine that two of the fans, e.g., fan 1 and fan 6 are reporting faulty, and one of the PSUs, e.g., PSU 1, are reporting faults, which can result in DMC communicating, e.g., via 112, to SMC 110, the following example cause alerts: Fan001_1 (fan #1 spinning low), severity is warning at timestamp TS1, Fan002_6 (fan #6 not spinning), severity is warning at timestamp TS2, PSU001_1 (PSU #1 faulty), severity is critical at timestamp TS3. SMC 110 can log these alerts and can enable access to the logged alerts, such as by an admin, e.g., via an alert log, a summary alert view, etc. In embodiments of the disclosed subject matter, access to the alerts can be facilitated by SMC-User interface component (SMCUIC) 130, for example, generating a render via a display that an example admin can view, etc. In some embodiments, SMC 110 can trigger a resolution event, for example, causing a ticketing system connected to SMC 110 to generate a parts order. As an example, cause-clear resolution component (CCRC) 160 can access alerts via SMC 110 and can correspondingly trigger parts ordering, dispatch of repair personnel, or elevating resolution to another entity/system, such as contacting a sales department to propose a customer purchase additional warranty time when a cause alert corresponds to an expiring warranty for a device/service, contacting remote support agent to contact a customer and walk through troubleshooting steps, or other resolution events. In this above six fan and two PSU example, system 100, via SMC 110 can cause a ticketing system, e.g., CCRC 160, to generate a parts replacement request for two fans, and one PSU based on the cause alerts at TS1, TS2, and TS3.

In embodiments, SMC 110 can also receive clear alerts that can correspond to resolution of a problem, fault, condition, etc., of a device, device environment, etc. A clear alert, according to the presently disclosed subject matter can comprise an indication of a device or device role, e.g., a device unique identifier, a device role identifier that allows distinguishing the device role from other similar device roles, etc. Moreover, a clear alert can comprise metadata such as a cause alert identifier (causeMsgID), a clear alert identifier (clearMsgID), a current system health value after a clear alert (sysHealthCond), a timestamp of a preceding alert, for example a timestamp corresponding to a first corresponding cause alert (firstCauseTS), etc., or other metadata. Returning to the above six fan and two PSU example, the fault at fan #1 can resolve, e.g., the fault can be cured, which can trigger a clear alert, such as, Fan003_1 (fan 1 is normal) with ‘info’ severity, where Fan003_1 indicates a third fan alert for fan #1, where fan #1 is now spinning nominally, which is associated with an info-level severity. The example clear alert can further comprise metadata <Fan003_1, {Fan001_1}, Critical, TS1>, which can indicate clearMsgID as Fan003_1 to identify the clear alert, causeMsgID as Fan001_1 to identify the preceding cause alert for fan 1 in the first fan alert; sysHealthCond as ‘Critical’ to indicate that even though fan #1 is now running normally the server is still in critical health for other reasons, e.g., the failing PSU #1 and Fan #6 not spinning, and firstCauseTS as ‘TS1’ identifying the time stamp of the cause alert Fan001_1. In this example, the disclosed correlation between the cause alert and the clear alert can be facilitated by directly including identifiers and metadata in the clear alert that reference a corresponding cause alert, e.g., clear alert Fan003_1 indicates the corresponding cause alert Fan001_1 at TS1. This can enable SMC 110 to rapidly clear the preceding cause alert and affiliated resolution events, e.g., SMC 110 can rescind, via CCRC 160, the order for at least one fan where fan #1 is now indicated as functioning normally after clearing the correlated cause alert. However, the included metadata further indicates that, despite clearing the cause alert Fan001_1, the system is still in a critical health condition, e.g., sysHealthCond as ‘Critical’ to indicate that even though fan 1 is now running normally the server is still in critical health for other reasons, e.g., the failing PSU #1 and Fan #6 not spinning. Accordingly, the remaining parts order for the other replacement fan and the replacement PSU can be maintained. In general, a clear alert can be of the form [alert number_device/role identifier, {cause event(s) identification}, post-resolution severity indicator, timestamp], for example [clearMsgID, causeMsgID, sysHealthCond, firstCauseTS].

Continuing with this example, the malfunction of PSU #1 can be resolved, for example when lab personnel manually reconnect a loose connection to PSU #1, which can result in a DMC generating another clear alert. This next clear alert, for example, can be PSU002_1 (PSU nominal) and alert metadata can contain <PSU002_1, {PSU001_1}, warning, null>, where a clearMsgID can be PSU002_1 to identify the clear alert, causeMsgID can indicate a corresponding cause alert as PSU001_1, and sysHealthCond as ‘warning’ to indicate that even though the PSU is again nominal, there remains a faulty fan, e.g., fan #6, and in this example timestamp information can be empty, e.g., ‘null’. As in the clear alert for fan #1, the clear alert for PSU #1 can be readily correlated to the correct cause alert, e.g., clear alert PSU002_1 can be correlated back to cause alert PSU001_1 at TS3 based on the clearMsgID and the causeMsgID, even without a timestamp. Accordingly, SMC 110 can clear cause alert PSU001_1 based on PSU002_1. Moreover, SMC 110, for example via CCRC 160, can rescind the order for a replacement PSU that was ticketed as a result of the earlier cause alert PSU001_1. Further, SMC 110 can, for example via SMCUIC 130, present the system health at a ‘warning’ level of health based on the remaining cause alert for failed fan #6, e.g., an alert log view can indicate all cause and clear alerts to an admin, which view can also indicate which cause alerts have been cleared, can indicate to an admin in an summary alert view only uncleared cause alerts, or other systems administration information based on the disclosed correlation between cause and clear alerts. It is noted that, as one result of the identification of a corresponding cause alert, a clear alert can be correlated to cause alerts generated in different firmware versions of devices, e.g., the clear alert can identify a device/role and a corresponding earlier cause alert that can provide positive correlation between the cause and clear alerts to enable clearing the correct alerts even where the device/role is associated with a different firmware installation. This can allow a customer to update device firmware without concern about breaking cause clear alarm correlation.

In embodiments, cause and clear alerts can be applied to software, environmental conditions, etc., that are not typically related to hardware componentry. As an example, a cause event can be generated when a server is moved from a designated installed location. A clear alert can be generated for this server where, for example, an admin updates the designated installed location to the current installed location. In an aspect, this can allow for a DMC to monitor equipment for conditions other than typical hardware failure events, e.g., monitoring for location, connections to prohibited resources/networks, aging of hardware, such as time since install, etc., access outside of designated time windows, thermal conditions, flooding or other natural disasters, such as tipping in an earthquake, power disruptions via loss of connectivity, etc., or other environmental conditions. As another example, an alert can be generated where the server is no longer covered by warranty, e.g., an original manufacturer or 3^{rd} party warranty, etc. Similarly, a clear alert can be generated where a customer purchases an extension of the warranty period. This example illustrate that software can be monitored by a DMC alerts can be reported to SMC 110 for software events. It is further noted that system 100 is illustrated relative to SMC 110, which can access alerts that can be generated by other devices, e.g., a DMC, that can be regarded as external to system 100. SMC 110 can perform actions based on analysis of an alert message that comprises the aforementioned identification and metadata, regardless of what the source of the alerts is. As such, system 100 can be discrete from other systems, devices, etc., for example, system 100 can be discrete from system 200. However, in some embodiments an SMC and a DMC can be comprised in a same system, for example system 500 can comprise SMC 510, which can be the same as or similar to SMC 110, etc., and DMC 520, which, for example, can be the same as, or similar to, DMC 220, etc.

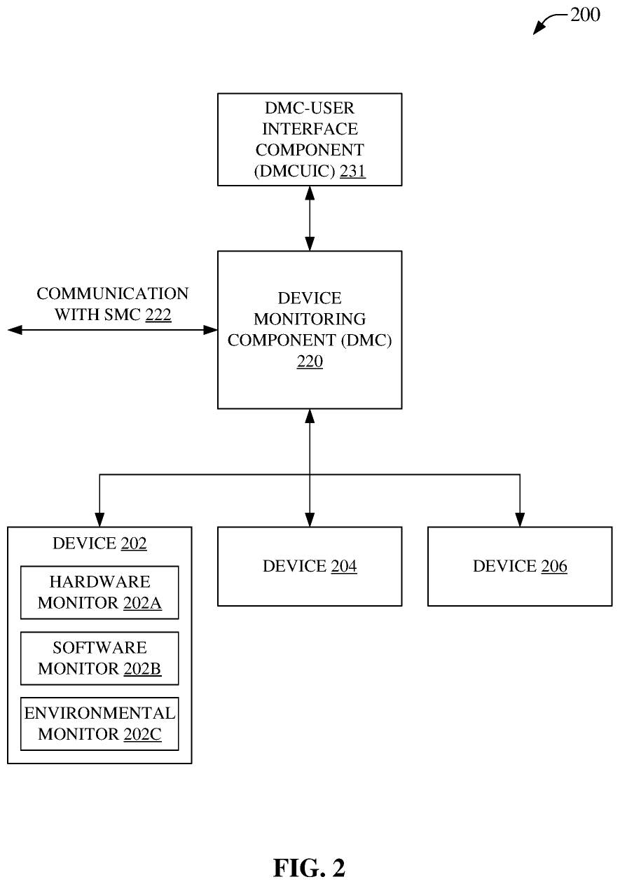

FIG. 2 is an illustration of an example system 200 enabling edge-side cause alert and clear alert correlation, in accordance with one or more embodiments of the subject disclosure. System 200 can comprise device monitoring component (DMC) 220 that can communicate with an SMC, such as SMC 110, etc., e.g., via communication with SMC 222. DMC 220 can generate an alert, e.g., a cause alert, a clear alert, etc., based monitoring a problem, fault, condition, etc., of a device, device environment, etc., e.g., device 202-206, etc. Alerts can relate to a hardware condition, e.g., via hardware monitor 202A, a software condition, e.g., via software monitor 202B, an environmental condition, e.g., via environmental monitor 202C, etc., As examples, a cause alert can indicate a failure of a power supply device, a memory module, a fan, a connection, etc., e.g., based on information from hardware monitor 202A, can indicate a temperature of a device environment, incursion of water into a device environment, etc., e.g., based on information from environmental monitor 202C, can indicate condition of a device, such as a warranty state, a spin speed of a hard drive, a software fault, etc., or other problem, fault, condition, etc., e.g., based on information from software monitor 202B, of a device, device environment, etc.

In some embodiments, a cause alert can indicate an alert identifier, for example cause alert 1, cause alert 2, . . . , cause alert n, etc. In some embodiments, a cause alert can indicate a device or device role identifier, for example, device serial number XYZ, device in position number four, etc. In some embodiments, a cause alert can indicate a problem, fault, etc., associated with the cause alert, for example, ‘fan not spinning,’ ‘DIMM failure,’ ‘power supply voltage low (or a specific voltage),’ etc. In some embodiments, a cause alert can indicate a timestamp. In some embodiments, a cause alert can indicate an alert level, for example, ‘severity is warning,’ ‘severity is critical,’ etc. In general, a cause alert can be of the form [alert number_device/role identifier, event information, severity indicator, timestamp], as examples: [causeMsgID, event information, sysHealthCond, firstCauseTS], [Fan001_1 (fan #1 spinning low), severity is warning at timestamp TS1], etc.

DMC 220 can log these alerts, e.g., via an alert log, a summary alert view, etc., and can enable access to the logged alerts, such as by an admin via DMC-user interface component (DMCUIC) 231, via SMC 110 and SMCUIC 130, etc. In embodiments of the disclosed subject matter, access to the alerts can be facilitated by DMCUIC 231 in a manner similar to, or the same as, by SMCUIC 130, etc. Generally, DMCUIC 231 can facilitate access by a ‘local admin’ corresponding to the devices monitored by DMC 220, while SMCUIC 130, etc., can facilitate access by a ‘central admin’ corresponding to devices monitored at the system level by one or more DMCs, e.g., the DMCUIC 231 can enable access to alerts for a subset of the devices monitored by SMCUIC 130, etc. As an example, an SMC can monitor two data centers each having a local DMC 220. In this example, DMCUIC 231 corresponding to the first local DMC 220 of the first data center can enable access to alerts corresponding to devices of the first data center. In contrast, an SMCUIC corresponding to the example SMC can enable access to alerts corresponding to devices of both the first and the second of the two data centers. In this regard, an SMCUIC can be considered an interface for a higher tier of devices and a DMCUIC can be regarded as an interface to a lower tier of the same devices.

In embodiments, DMC 220 can generate alerts that can be consumed by an SMC, e.g., SMC 110, etc., which can, at the system level, trigger a resolution event, for example, causing a ticketing system connected to SMC 110 to generate a parts order, such as via CCRC 160, etc. While not illustrated to reduce repetitiveness, and for the sake of clarity and brevity, DMC 220, in some embodiments, can also, at a local level, trigger a resolution event that can be the same as, or similar to such a one cause by an SMC at the system level. Generally, resolution events can be performed at a local or system level based on a preference of the customer. As an example, a local technician can be alerted to provide service via a local resolution event trigger from DMC 220, while a parts order resolution event can be triggered via a system level SMC, e.g., SMC 110, etc. In a more complex example, DMC 220 can trigger a local parts query as a resolution and, where a replacement part is not locally available, can indicate that an SMC can place a parts order and service ticket.

In embodiments, DMC 220 can also generate clear alerts that can correspond to resolution of a problem, fault, condition, etc., of a device, device environment, etc. A clear alert, according to the presently disclosed subject matter can comprise an indication of a device or device role, e.g., a device unique identifier, a device role identifier that allows distinguishing the device role from other similar device roles, etc. Moreover, a clear alert can comprise metadata such as a cause alert identifier (causeMsgID), a clear alert identifier (clearMsgID), a current system health value after a clear alert (sysHealthCond), a timestamp of a preceding alert, for example a timestamp corresponding to a first corresponding cause alert (firstCauseTS), etc., or other metadata. In general, a clear alert can be of the form [alert number_device/role identifier, {cause event(s) identification}, post-resolution severity indicator, timestamp], for example [clearMsgID, causeMsgID, sysHealthCond, firstCauseTS]. Further, DMC 220 can, for example via DMCUIC 231, present an alert log view that can indicate all cause and clear alerts to a local admin, which view can also indicate which cause alerts have been cleared, can indicate to a local admin in a summary alert view only uncleared cause alerts, or other local systems administration information based on the disclosed correlation between cause and clear alerts. Local presentation of alerts via DMCUIC 231 can be in addition to any system level presentation of alerts, for example, via SMC 110 and SMCUIC 130. It is noted that, as one result of the identification of a corresponding cause alert, a clear alert can be correlated to cause alerts generated in different firmware versions of devices, e.g., the clear alert can identify a device/role and a corresponding earlier cause alert that can provide positive correlation between the cause and clear alerts to enable clearing the correct alerts even where the device/role is associated with a different firmware installation. This can allow a customer to update device firmware without concern about breaking cause clear alarm correlation.

In embodiments, cause and clear alerts can be applied to software, environmental conditions, etc., that are not typically related to hardware componentry. As an example, a cause event can be generated by environmental monitor 202C when a server is moved from a designated installed location. A clear alert can be generated for this server where, for example, an admin updates the designated installed location to the current installed location. In an aspect, this can allow for DMC 220 to monitor equipment for conditions other than typical hardware failure events, e.g., monitoring for location, connections to prohibited resources/networks, aging of hardware, such as time since install, etc., access outside of designated time windows, thermal conditions, flooding or other natural disasters, such as tipping in an earthquake, power disruptions via loss of connectivity, etc., or other environmental conditions. As another example, an alert can be generated by software monitor 202B where the server is no longer covered by warranty, e.g., an original manufacturer or 3^{rd} party warranty, etc. Similarly, a clear alert can be generated where a customer purchases an extension of the warranty period. This example illustrate that software can be monitored by DMC 220 and alerts can be reported to an SMC, or to a local admin via DMCUIC 231, for software events. It is further noted that system 200 is illustrated relative to DMC 220, which can enable access alerts for other devices, e.g., an SMC, such as SMC 110, etc., that can be regarded as external to system 200. DMC 220 can generate alert message that comprises the aforementioned identification and metadata, regardless of what other system or device consumes these alerts. As such, system 200 can be discrete from other systems, devices, etc., for example, system 200 can be discrete from system 100. However, in some embodiments an SMC and a DMC can be comprised in a same system, for example system 500 can comprise SMC 510, which can be the same as or similar to SMC 110, etc., and DMC 520, which, for example, can be the same as, or similar to, DMC 220, etc.

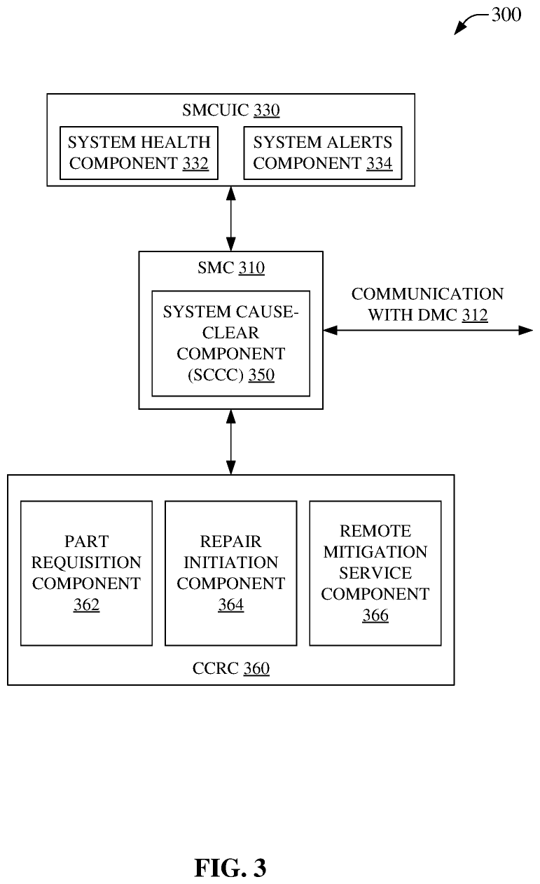

FIG. 3 is an illustration of a system 300, which can facilitate system-side notification of, and responses to, a system alert based on cause alert and clear alert correlation, in accordance with embodiments of the subject disclosure. System 300 can comprise system management component (SMC) 310 that can communicate with a DMC, e.g., via communication with DMC 312. SMC 310 can receive an alert, e.g., a cause alert, a clear alert, etc. A cause alert can indicate a problem, fault, condition, etc., of a device, device environment, etc. As examples, a cause alert can indicate a failure of a power supply device, a memory module, a fan, a connection, etc., can indicate a temperature of a device environment, incursion of water into a device environment, etc., can indicate condition of a device, such as a warranty state, a spin speed of a hard drive, a software fault, etc., or other problem, fault, condition, etc., of a device, device environment, etc.

In some embodiments, a cause alert can indicate an alert identifier, for example cause alert 1, cause alert 2, . . . , cause alert n, etc. In some embodiments, a cause alert can indicate a device or device role identifier, for example, device serial number XYZ, device in position number four, etc. In some embodiments, a cause alert can indicate a problem, fault, etc., associated with the cause alert, for example, ‘fan not spinning,’ ‘DIMM failure,’ ‘power supply voltage low (or a specific voltage),’ etc. In some embodiments, a cause alert can indicate a timestamp. In some embodiments, a cause alert can indicate an alert level, for example, ‘severity is warning,’ ‘severity is critical,’ etc. In general, a cause alert can be of the form [alert number_device/role identifier, event information, severity indicator, timestamp], for example [causeMsgID, event information, sysHealthCond, firstCauseTS]. SMC 310 can log alerts and can enable access to the logged alerts, such as by an admin, e.g., via an alert log, a summary alert view, etc. In embodiments of the disclosed subject matter, access to the alerts can be facilitated by SMC-User interface component (SMCUIC) 330, for example, generating a render via a display that an example admin can view, etc.

In embodiments, SMC 310 can also receive clear alerts that can correspond to resolution of a problem, fault, condition, etc., of a device, device environment, etc. A clear alert, according to the presently disclosed subject matter can comprise an indication of a device or device role, e.g., a device unique identifier, a device role identifier that allows distinguishing the device role from other similar device roles, etc. Moreover, a clear alert can comprise metadata such as a cause alert identifier (causeMsgID), a clear alert identifier (clearMsgID), a current system health value after a clear alert (sysHealthCond), a timestamp of a preceding alert, for example a timestamp corresponding to a first corresponding cause alert (firstCauseTS), etc., or other metadata. This can enable SMC 310 to rapidly clear preceding cause alerts and affiliated resolution events. In general, a clear alert can be of the form [alert number_device/role identifier, {cause event(s) identification}, post-resolution severity indicator, timestamp], for example [clearMsgID, causeMsgID, sysHealthCond, firstCauseTS]. It is noted that, as one result of the identification of a corresponding cause alert, a clear alert can be correlated to cause alerts generated in different firmware versions of devices, e.g., the clear alert can identify a device/role and a corresponding earlier cause alert that can provide positive correlation between the cause and clear alerts to enable clearing the correct alerts even where the device/role is associated with a different firmware installation. This can allow a customer to update device firmware without concern about breaking cause clear alarm correlation.

In some embodiments, SMCUIC 330 can comprise a system health component 332 that can determine system health information based on alerts, e.g., on cause and clear alerts. As an example, if there are multiple cause alerts that have not been cleared based on clear alerts, system health can be indicated by the system condition indicated in the remaining cause alerts. In this regard, an admin can access overall system health information via system health component 332. In some embodiments, SMCUIC 330 can comprise system alerts component 334 that can enable access to alerts, e.g., cause alerts, clear alerts, or combinations thereof. In embodiments, this access to alerts can comprise presenting alert information in one or more modalities, for example via a display of all logged alerts, a display of remaining uncleared cause alerts, or other visual renderings of alerts. In some embodiments, non-visual modalities can be employed to provide access to alert information, for example, audio information, audible alarms, haptics, etc.

In some embodiments, SMC 310 can comprise system caused-clear component (SCCC) 350 that can correlate cause and clear alerts. SCCC 350 can determine cause alerts that have been resolved based on clear alerts. As such, SCCC 350 can reduce a count of active cause alerts by marking some cause alerts as resolved. This can facilitate presenting an admin access to alert information that can be more compact and meaningful by comprising just active cause alerts rather than all alerts. In some embodiments, SCCC 350 can also facilitate admin access to all alerts wherein resolved alerts are indicated differently than active alerts, for example active alerts can be rendered in a red color, clear alerts can be rendered in a green color, and resolved alerts can be rendered in a grey color, allowing an admin to visually identify the red colored alerts.

In some embodiments, SMC 310 can trigger a resolution event, for example, causing a ticketing system connected to SMC 310 to generate a parts order via part requisition component 362 of CCRC 360. As an example, CCRC 360 can access alerts via SMC 310 and can correspondingly trigger, via part requisition component 362, parts ordering, dispatch of repair personnel, via repair initiation component 364, or elevating resolution to another entity/system, such as contacting a sales department to propose a customer purchase additional warranty time when a cause alert corresponds to an expiring warranty for a device/service, contacting remote support agent to contact a customer and walk through troubleshooting steps, or other resolution events via remote mitigation service component 366.

In embodiments, cause and clear alerts can be applied to software, environmental conditions, etc., that are not typically related to hardware componentry. As an example, a cause event can be generated when a server is moved from a designated installed location. A clear alert can be generated for this server where, for example, an admin updates the designated installed location to the current installed location. In an aspect, this can allow for a DMC to monitor equipment for conditions other than typical hardware failure events, e.g., monitoring for location, connections to prohibited resources/networks, aging of hardware, such as time since install, etc., access outside of designated time windows, thermal conditions, flooding or other natural disasters, such as tipping in an earthquake, power disruptions via loss of connectivity, etc., or other environmental conditions. As another example, an alert can be generated where the server is no longer covered by warranty, e.g., an original manufacturer or 3^{rd} party warranty, etc. Similarly, a clear alert can be generated where a customer purchases an extension of the warranty period. This example illustrate that software can be monitored by a DMC alerts can be reported to SMC 310 for software events. It is further noted that system 300 is illustrated relative to SMC 310, which can access alerts that can be generated by other devices, e.g., a DMC, that can be regarded as external to system 300. SMC 310 can perform actions based on analysis of an alert message that comprises the aforementioned identification and metadata, regardless of what the source of the alerts is. As such, system 300 can be discrete from other systems, devices, etc., for example, system 300 can be discrete from system 200, 400, etc. However, in some embodiments an SMC and a DMC can be comprised in a same system, for example system 500 can comprise SMC 510, which can be the same as or similar to SMC 110, 310, etc., and DMC 520, which, for example, can be the same as, or similar to, DMC 220, 420, etc.

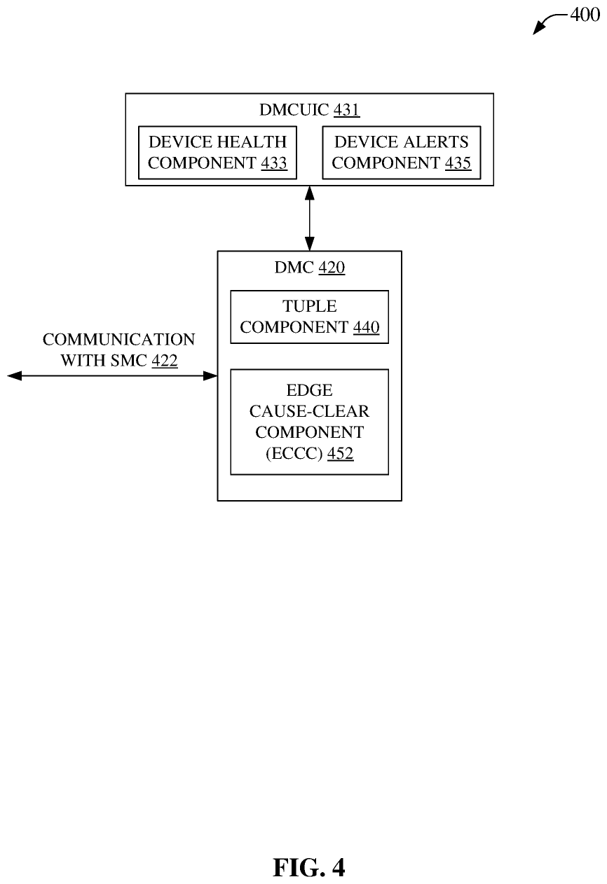

FIG. 4 is an illustration of a system 400 that can enable tuple generation facilitating cause alert and clear alert correlation, in accordance with embodiments of the subject disclosure. System 400 can comprise device monitoring component (DMC) 420 that can communicate with an SMC, such as SMC 110, 310, etc., e.g., via communication with SMC 422. DMC 420 can generate an alert, e.g., a cause alert, a clear alert, etc., based monitoring a problem, fault, condition, etc., of a device, device environment, etc., e.g., device 202-206, etc. Alerts can relate to a hardware condition, a software condition, an environmental condition, etc., As examples, a cause alert can indicate a failure of a power supply device, a memory module, a fan, a connection, etc., can indicate a temperature of a device environment, incursion of water into a device environment, etc., can indicate condition of a device, such as a warranty state, a spin speed of a hard drive, a software fault, etc., or other problem, fault, condition, etc., of a device, device environment, etc.

In embodiments, DMC 420 can generate alerts that can be consumed by an SMC, e.g., SMC 110, 310, etc., which can, at the system level, trigger a resolution event, for example, causing a ticketing system connected to SMC 110, 310, etc., to generate a parts order, such as via CCRC 160, 360, etc. While not illustrated to reduce repetitiveness, and for the sake of clarity and brevity, DMC 420, in some embodiments, can also, at a local level, trigger a resolution event that can be the same as, or similar to such a one cause by an SMC at the system level. Generally, resolution events can be performed at a local or system level based on a preference of the customer.

In some embodiments, a cause alert can indicate an alert identifier, for example cause alert 1, cause alert 2, . . . , cause alert n, etc. In some embodiments, a cause alert can indicate a device or device role identifier, for example, device serial number XYZ, device in position number four, etc. In some embodiments, a cause alert can indicate a problem, fault, etc., associated with the cause alert, for example, ‘fan not spinning,’ ‘DIMM failure,’ ‘power supply voltage low (or a specific voltage),’ etc. In some embodiments, a cause alert can indicate a timestamp. In some embodiments, a cause alert can indicate an alert level, for example, ‘severity is warning,’ ‘severity is critical,’ etc. In general, a cause alert can be of the form [alert number_device/role identifier, event information, severity indicator, timestamp], as examples: [causeMsgID, event information, sysHealthCond, firstCauseTS], [Fan001_1 (fan #1 spinning low), severity is warning at timestamp TS1], etc.

In embodiments, DMC 420 can also generate clear alerts that can correspond to resolution of a problem, fault, condition, etc., of a device, device environment, etc. A clear alert, according to the presently disclosed subject matter can comprise an indication of a device or device role, e.g., a device unique identifier, a device role identifier that allows distinguishing the device role from other similar device roles, etc. Moreover, a clear alert can comprise metadata such as a cause alert identifier (causeMsgID), a clear alert identifier (clearMsgID), a current system health value after a clear alert (sysHealthCond), a timestamp of a preceding alert, for example a timestamp corresponding to a first corresponding cause alert (firstCauseTS), etc., or other metadata. In general, a clear alert can be of the form [alert number_device/role identifier, {cause event(s) identification}, post-resolution severity indicator, timestamp], for example [clearMsgID, causeMsgID, sysHealthCond, firstCauseTS]. Further, DMC 420 can, for example via DMCUIC 431, present an alert log view that can indicate all cause and clear alerts to a local admin, which view can also indicate which cause alerts have been cleared, can indicate to a local admin in a summary alert view only uncleared cause alerts, or other local systems administration information based on the disclosed correlation between cause and clear alerts. Local presentation of alerts via DMCUIC 431 can be in addition to any system level presentation of alerts, for example, via SMC 110, 310, etc., and SMCUIC 130, 330, etc. It is noted that, as one result of the identification of a corresponding cause alert, a clear alert can be correlated to cause alerts generated in different firmware versions of devices, e.g., the clear alert can identify a device/role and a corresponding earlier cause alert that can provide positive correlation between the cause and clear alerts to enable clearing the correct alerts even where the device/role is associated with a different firmware installation. This can allow a customer to update device firmware without concern about breaking cause clear alarm correlation.

In some embodiments, DMC 420 can comprise tuple component 440 that can produce an n-tuple that can be comprised in an alert, e.g., a cause alert can comprise a tuple produced by tuple component 440, a clear alert can comprise a tuple produced by tuple component 440, etc. A tuple can comprise a variable number of arguments and arguments can comprise a variable number of data elements, e.g., a tuple can be an n-tuple. In an example, a cause alert can comprise the tuple [causeMsgID, event information, sysHealthCond, firstCauseTS]. In another example, a clear alert can comprise the tuple [clearMsgID, causeMsgID, sysHealthCond, firstCauseTS]. In this example, the argument causeMsgID can comprise a group of causeMsgIDs for one or more cause alerts, e.g., causeMsgID can be {cause alert 1, cause alert 2, cause alert 3, . . . , cause alert n}, which can indicate that the indicated clearMsgID corresponds to ‘n’ cause alerts.

In some embodiments, DMC 420 can comprise edge caused-clear component (ECCC) 452 that can correlate cause and clear alerts. ECCC 452 can determine cause alerts that have been resolved based on clear alerts. As such, ECCC 452 can reduce a count of active cause alerts by marking some cause alerts as resolved. This can facilitate presenting a local admin, e.g., an admin local to devices at an edge of a network as compared to a centralized SMC, etc., access to alert information that can be more compact and meaningful by comprising just active cause alerts rather than all alerts. In some embodiments, ECCC 452 can also facilitate local admin access to all local alerts, wherein resolved alerts are indicated differently than active alerts.

DMC 420 can log alerts, e.g., via an alert log, a summary alert view, etc., and can enable access to the logged alerts, such as by an admin via DMC-user interface component (DMCUIC) 431, via SMC 110 and SMCUIC 130, via SMC 310 and SMCUIC 330, etc. In embodiments of the disclosed subject matter, access to the alerts can be facilitated by DMCUIC 431 in a manner similar to, or the same as, by SMCUIC 130, 330, etc. Generally, DMCUIC 431 can facilitate access by a ‘local admin’ corresponding to the devices monitored by DMC 420, while SMCUIC 130, 330, etc., can facilitate access by a ‘central admin’ corresponding to devices monitored at the system level by one or more DMCs, e.g., the DMCUIC 431 can enable access to alerts for a subset of the devices monitored by SMCUIC 130, 330, etc. In some embodiments, DMCUIC 431 can comprise a device health component 433 that can determine local device health information based on alerts, e.g., on cause and clear alerts. As an example, if there are multiple cause alerts that have not been cleared based on clear alerts, local device health can be indicated by the system condition for local devices indicated in the remaining cause alerts. In this regard, a local admin can access local device health information via device health component 433. This can be similar to system health component 332, etc., but at a local device level rather than at an overall system level. In some embodiments, DMCUIC 431 can comprise device alerts component 435 that can enable access to local alerts, e.g., cause alerts, clear alerts, or combinations thereof. In embodiments, this access to local alerts can comprise presenting alert information in one or more modalities, for example via a display of all logged local alerts, a display of remaining uncleared local cause alerts, or other visual renderings of local alerts. In some embodiments, non-visual modalities can be employed to provide access to local alert information, for example, audio information, audible alarms, haptics, etc. This can be similar to device alerts component 334, etc., but at a local device level rather than at an overall system level.

In embodiments, cause and clear alerts can be applied to software, environmental conditions, etc., that are not typically related to hardware componentry. In an aspect, this can allow for DMC 420 to monitor equipment for conditions other than typical hardware failure events, e.g., monitoring for location, connections to prohibited resources/networks, aging of hardware, such as time since install, etc., access outside of designated time windows, thermal conditions, flooding or other natural disasters, such as tipping in an earthquake, power disruptions via loss of connectivity, etc., or other environmental conditions. It is further noted that system 400 is illustrated relative to DMC 420, which can enable access alerts for other devices, e.g., an SMC, such as SMC 110, 330, etc., that can be regarded as external to system 400. DMC 420 can generate alert message that comprises the aforementioned identification and metadata, regardless of what other system or device consumes these alerts. As such, system 400 can be discrete from other systems, devices, etc., for example, system 400 can be discrete from system 100, 300, etc. However, in some embodiments an SMC and a DMC can be comprised in a same system, for example system 500 can comprise SMC 510, which can be the same as or similar to SMC 110, 330, etc., and DMC 520, which, for example, can be the same as, or similar to, DMC 220, 420, etc.

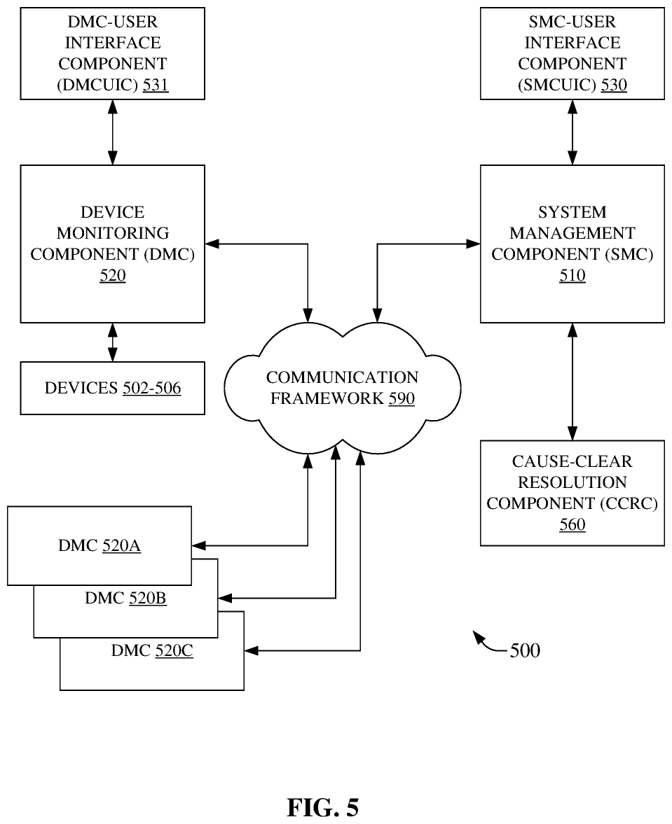

FIG. 5 is an illustration of a system 500, which can facilitate cause alert and clear alert correlation corresponding to one or more edge zones, in accordance with embodiments of the subject disclosure. System 500 can comprise DMC 520 that can generate alerts that can be accessed by SMC 510 via communication framework 590. Similarly, DMCs 520A-520C, etc., can also generate alerts that can be accessed by SMC 510. Alerts generated by DMC 520 can be based on monitoring devices 502-506, etc., and, correspondingly, DMCs 520A-520C, etc., can each monitor devices local to those DMCs. In this regard, SMC 510 can manage alerts at a ‘system level’ for alerts from each of DMC 520, 520A, 520B, 520C, etc. As such, SMCUIC 530 can enable system-level admin access to alerts from all DMCs, while in contrast, DMCUIC 531 can enable local-level admin access to alerts from DMC 520 based on monitoring of devices 502-506, but generally not for devices corresponding to any of DMCs 520A-520C. SMC 510 can employ CCRC 560 to trigger a resolution event, for example, causing a ticketing system connected to SMC 510 to generate a parts order via CCRC 560, for example relative to a malfunction of device 502 based on cause and clear alerts from DMC 520. CCRC 560 can access alerts via SMC 510 and can correspondingly trigger parts ordering, dispatch of repair personnel, elevating resolution to another entity/system, such as contacting a sales department, contacting remote support agent to contact a customer and walk through troubleshooting steps, or other resolution events, etc.

It has been generally noted hereinabove that discrete systems can exist relative to an SMC, or a DMC, e.g., systems 100 and 300 do not need to comprise an alert generating component where SMC 110, 310, etc., can base an action, e.g., enabling access by an admin to correlated alerts, triggering a resolution action, etc., where SMC 110, 310, etc., can receive a cause alert, a clear alert, or combination thereof, and systems 200 and 400 can generating alerts in the absence of an SMC, based on monitoring local devices, device environment, executing software, etc. However, system 500 illustrates a more integrated high-level system comprising both a DMC, e.g., DMCs 520, 520A-520C, etc., and an SMC, e.g., SMC 510, etc. In embodiments of system 500, SMC 510 can be the same as or similar to SMC 110, 330, etc., and DMCs 520-520C can be the same as, or similar to, DMC 220, 420, etc.

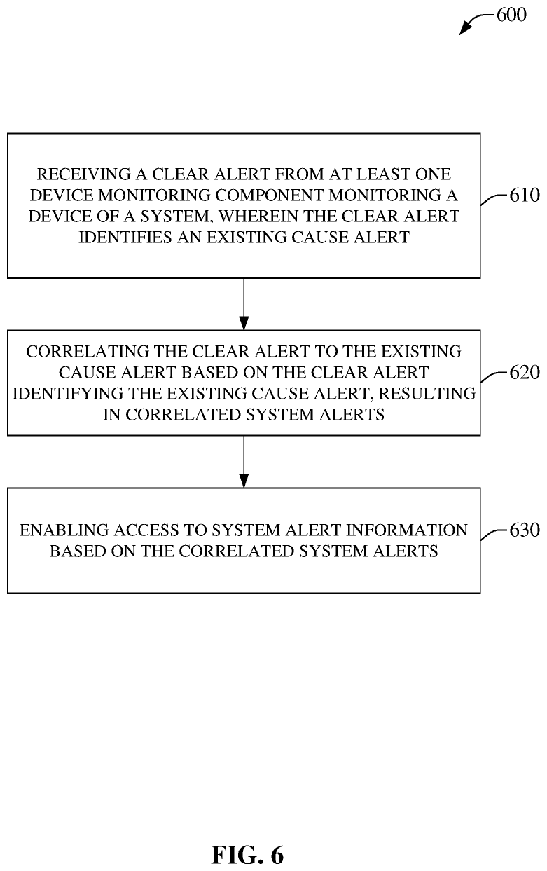

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternately be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more embodiments herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 is an illustration of an example method 600, which can facilitate cause alert and clear alert correlation, in accordance with embodiments of the subject disclosure. At 610, method 600 can comprise receiving a clear alert from at least one device monitoring component monitoring a device of a system, wherein the clear alert identifies an existing cause alert. A clear alert can correspond to resolution of a problem, fault, condition, etc., of a device, device environment, etc. A clear alert, according to the presently disclosed subject matter can comprise an indication of a device or device role, e.g., a device unique identifier, a device role identifier that allows distinguishing the device role from other similar device roles, etc. Moreover, a clear alert can comprise metadata such as a cause alert identifier (causeMsgID), a clear alert identifier (clearMsgID), a current system health value after a clear alert (sysHealthCond), a timestamp of a preceding alert, for example a timestamp corresponding to a first corresponding cause alert (firstCauseTS), etc., or other metadata. Given that a clear alert can correspond to resolution of a problem, fault, condition, etc., of a device, device environment, etc., the clear alert can be related to a cause alert that can be generated in response to the problem, fault, condition, etc., of the device, device environment, etc., that has been resolved as indicated in the clear alert. Accordingly, the clear alert can identify the cause alert it is related to, e.g., a clear alert can comprise a causeMsgID, or other identifier of a related cause alert. This can enable system 600 to rapidly clear the preceding cause alert, alter affiliated resolution events, etc. In general, a clear alert can be of the form [alert number_device/role identifier, {cause event(s) identification}, post-resolution severity indicator, timestamp], for example [clearMsgID, causeMsgID, sysHealthCond, firstCauseTS].

Method 600, at 620, can comprise correlating the clear alert to the existing cause alert based on the clear alert identifying the existing cause alert, resulting in correlated system alerts. The correlation of the clear alert to an existing cause alert can be based on the identification of the cause alert comprised in the clear alert. It is noted that the cause alert and clear alert can be independently received and not be initially correlated, e.g., correlation at the device level can be based on the cause and clear alerts indicating a same device, same device role, etc., and correlation at the system management level can be based on the identity of a cause alert indicated in a clear alert, etc. As such, identifying the existing cause alert in the clear alert can be highly effective in enabling a system management component, e.g., SMC 110, 310, 510, etc., to correlate the cause and clear alert, which can facilitate indicating a correlated cause alert as resolved, changed, improved, worsened, continuing, etc. The correlation between the cause and clear alerts can enable an admin access to pertinent information more readily that simply inundating an admin with all alerts in the absence of indicating correlated alerts, resolved alerts, etc. This can allow more responsive management, resolution events, etc.

At 630, method 600 can comprise enabling access to system alert information based on the correlated system alerts. At this point, method 600 can end. Access to system alert information can comprise admin access to an alert log, summary alert log, system health page, etc., that can reflect correlations between cause alerts and clear alerts. As such, clear alerts can be employed to indicate correlated cause alerts, for example marking a cause alert as resolved based on a clear alert correlated to the cause alert. In this example, by marking the cause alert as resolved, the example admin can more easily focus their attention on other unresolved cause alerts. Further, as another example, marking of a cause alert as resolved can cause a ticketing system that can access the system alert information to rescind, alter, update, etc., a pending ticket propagated from the existing cause alert now marked as resolved. This can include updating a replacement part acquisition, updating dispatch of a repair technician, etc.

As has been noted hereinabove, a system responding to an alert, such as a clear alert, etc., can be independent of a system generating the alert. As such, method 600 can be responsive to the indicated clear alert, e.g., determining correlation to the existing cause alert, enabling access to system alert information, triggering a response event, etc., while being discrete from another method, e.g., method 700, etc., or system generating an alert, for example, systems 100, 300, etc., can be discrete from systems 200, 400, etc. However, in some embodiments, method 600 can be practiced in conjunction with another method relating to generating alerts, for example, in system 500, a DMC can generate alerts that an SMC can respond to, etc.

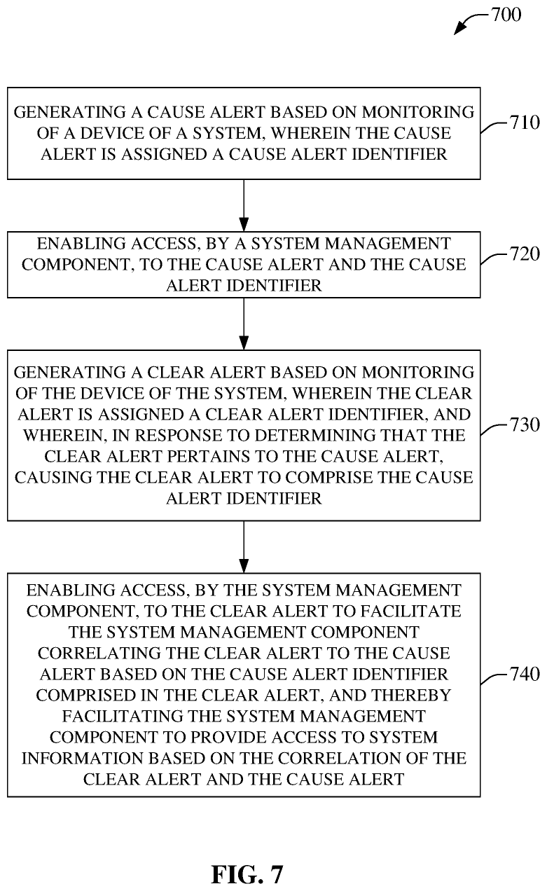

FIG. 7 is an illustration of an example method 700, which can facilitate tuple generation facilitating cause alert and clear alert correlation, in accordance with embodiments of the subject disclosure. At 710, method 700 can comprise generating a cause alert based on monitoring of a device of a system, wherein the cause alert is assigned a cause alert identifier. In embodiments, a cause alert can indicate a problem, fault, etc., associated with the cause alert, for example, ‘fan not spinning,’ ‘DIMM failure,’ ‘power supply voltage low (or a specific voltage),’ etc. In some embodiments, a cause alert can indicate a timestamp. In some embodiments, a cause alert can indicate an alert level, for example, ‘severity is warning,’ ‘severity is critical,’ etc. A cause alert can indicate a cause alert identifier, for example cause alert 1, cause alert 2, . . . , cause alert n, etc. In some embodiments, a cause alert can indicate a device or device role identifier, for example, device serial number XYZ, device in position number four, etc. In general, a cause alert can be of the form [alert number_device/role identifier, event information, severity indicator, timestamp], as examples: [causeMsgID, event information, sysHealthCond, firstCauseTS], [Fan001_1 (fan #1 spinning low), severity is warning at timestamp TS1], etc. Typically, cause alerts can be managed by an admin, can trigger a resolution event, etc.

Method 700, at 720, can comprise enabling access, by a system management component, to the cause alert and the cause alert identifier. Method 700 can provide access to the cause alert and the cause alert identifier to facilitate the system management component, for example, SMC 110, 310, 510, etc., providing access to the cause alert, such as by a system level admin, by a ticketing system to effect a resolution event, etc. In embodiments, cause alerts can be presented to an admin via an interface rendering an alert log view of some or all alerts, including cause alerts, a summary alert log view of outstanding alerts, again including cause alerts, a system health view based on correlated alerts, etc.

Method 700, at 730, can comprise generating a clear alert based on monitoring of the device of the system, wherein the clear alert is assigned a clear alert identifier, and wherein, in response to determining that the clear alert pertains to the cause alert, causing the clear alert to comprise the cause alert identifier. A generated clear alert can correspond to resolution of a problem, fault, condition, etc., of a device, device environment, etc. A clear alert, generated according to the presently disclosed subject matter, can comprise an indication of a device or device role, e.g., a device unique identifier, a device role identifier that allows distinguishing the device role from other similar device roles, etc. Moreover, a clear alert can comprise metadata such as a cause alert identifier (causeMsgID), a clear alert identifier (clearMsgID), a current system health value after a clear alert (sysHealthCond), a timestamp of a preceding alert, for example a timestamp corresponding to a first corresponding cause alert (firstCauseTS), etc., or other metadata. Given that a clear alert can correspond to resolution of a problem, fault, condition, etc., of a device, device environment, etc., the clear alert can be related to a cause alert that can be generated in response to the problem, fault, condition, etc., of the device, device environment, etc., that has been resolved as indicated in the clear alert. Accordingly, the clear alert can identify the cause alert that it is related to, e.g., a clear alert can comprise a causeMsgID, or other identifier of a related cause alert. This can enable system 700 to provide a clear alert that can be employed to rapidly clear an existing cause alert, alter affiliated resolution events, etc. In general, a clear alert can be of the form [alert number_device/role identifier, {cause event(s) identification}, post-resolution severity indicator, timestamp], for example [clearMsgID, causeMsgID, sysHealthCond, firstCauseTS].

At 740, method 700 can comprise enabling access, by the system management component, to the clear alert to facilitate the system management component correlating the clear alert to the cause alert based on the cause alert identifier comprised in the clear alert, and thereby facilitating the system management component to provide access to system information based on the correlation of the clear alert and the cause alert. At this point, method 700 can end. Providing access to the clear alert can enable an accessing system or method to identify a related cause alert, e.g., based on the cause alert identifier included in the clear alert. As such, the access to the clear alert can facilitate an accessing system or method correlating the clear alert to an existing cause alert. This in turn can facilitate the accessing system or method to enable access, e.g., by an admin, a ticketing system, etc., to system information based on the correlation of the cause and clear alerts. As an example, a clear alert can indicate a problem with a fan, previously reported in a cause alert, has been resolved, and can identify the preceding cause alert. Accordingly, in this example, an accessing system can be enabled to correlate the clear alert to the existing cause alert for the problem with the fan. The accessing system can be thereby enabled to mark the correlated cause alert as resolved and enable notification of an admin, for example via a user interface now rendering the existing cause event as resolved.

It is again noted that a system responding to an alert, such as a clear alert, etc., can be independent of a system generating the alert. As such, method 700 can independently generate an alert that can be responded to by another system, method, etc., e.g., method 600, system 100, 300, etc. However, in some embodiments, method 700 can be practiced in conjunction with another method relating to responding to alerts, for example, in system 500, a DMC can generate alerts that an SMC can respond to, etc.

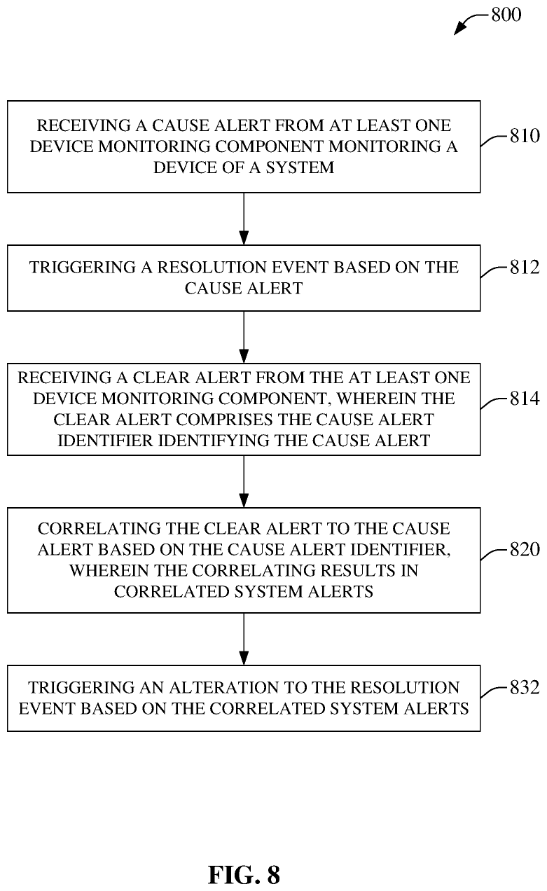

FIG. 8 is an illustration of an example method 800, which can facilitate responding to a system alert based on cause alert and clear alert correlation, in accordance with embodiments of the subject disclosure. At 810, method 800 can comprise receiving a cause alert from at least one device monitoring component monitoring a device of a system. A cause alert can be based on monitoring of a device of the system, for example by DMC 220, 420, 520, etc., wherein the cause alert can be assigned a cause alert identifier. In embodiments, a cause alert can indicate a problem, fault, etc., associated with the cause alert, for example, ‘fan not spinning,’ ‘DIMM failure,’ ‘power supply voltage low (or a specific voltage),’ etc. In some embodiments, a cause alert can indicate a timestamp. In some embodiments, a cause alert can indicate an alert level, for example, ‘severity is warning,’ ‘severity is critical,’ etc. A cause alert can indicate a cause alert identifier, for example cause alert 1, cause alert 2, . . . , cause alert n, etc. In some embodiments, a cause alert can indicate a device or device role identifier, for example, device serial number XYZ, device in position number four, etc. In general, a cause alert can be of the form [alert number_device/role identifier, event information, severity indicator, timestamp], as examples: [causeMsgID, event information, sysHealthCond, firstCauseTS], [Fan001_1 (fan #1 spinning low), severity is warning at timestamp TS1], etc. Typically, cause alerts can be managed by an admin, can trigger a resolution event, etc.

At 812, method 800 can comprise triggering a resolution event based on the cause alert. Whereas the cause alert can indicate a problem with hardware, software, an environment of a device, etc., the cause alert can trigger a resolution event to mitigate or cure the problem. As an example, a cause alert can indicate a failed PSU and a resolution event can be causing an admin to troubleshoot the failed PSU and, where appropriate to ticket a replacement PSU order. As another example, a cause alert can indicate that a software is out of date and a resolution event can be triggering a sales call to prompt the customer to update the software. In another example, a cause event can indicate high data center temperatures and a resolution event can be to initiate switching operations to a backup data center.

At 814, method 800 can comprise receiving a clear alert from the at least one device monitoring component, wherein the clear alert comprises the cause alert identifier identifying the cause alert. A received clear alert can correspond to resolution of a problem, fault, condition, etc., of a device, device environment, etc. A clear alert, generated according to the presently disclosed subject matter, can comprise an indication of a device or device role, e.g., a device unique identifier, a device role identifier that allows distinguishing the device role from other similar device roles, etc. Moreover, a clear alert can comprise metadata such as a cause alert identifier (causeMsgID), a clear alert identifier (clearMsgID), a current system health value after a clear alert (sysHealthCond), a timestamp of a preceding alert, for example a timestamp corresponding to a first corresponding cause alert (firstCauseTS), etc., or other metadata. Given that a clear alert can correspond to resolution of a problem, fault, condition, etc., of a device, device environment, etc., the clear alert can be related to a cause alert that can be generated in response to the problem, fault, condition, etc., of the device, device environment, etc., that has been resolved as indicated in the clear alert. Accordingly, receiving the clear alert can allow identification of the cause alert that it is related to, e.g., a clear alert can comprise a causeMsgID, or other identifier of a related cause alert. This can enable system 800 to rapidly clear an existing cause alert based on the identification of the cause alert comprised in the clear alert. In general, a clear alert can be of the form [alert number_device/role identifier, {cause event(s) identification}, post-resolution severity indicator, timestamp], for example [clearMsgID, causeMsgID, sysHealthCond, firstCauseTS].

Method 800, at 820, can comprise correlating the clear alert to the cause alert based on the cause alert identifier, wherein the correlating results in correlated system alerts. The clear alert can enable correlating the clear alert to a cause alert such that, for example, the correlated cause alert can be distinguished from other unresolved cause alerts, pending resolution events can be modified, etc. A clear alert can facilitate a receiving system or method to correlate the clear alert to an existing cause alert. This in turn can facilitate the receiving system or method to enable access, e.g., by an admin, a ticketing system, etc., to system information based on the correlation of the cause and clear alerts. As an example, a clear alert can indicate a problem with a fan, previously reported in a cause alert, has been resolved, and can identify the preceding cause alert. Accordingly, in this example, a system receiving the clear alert can correlate the clear alert to the existing cause alert for the problematic fan. The system can be thereby enabled to mark the correlated cause alert as resolved and enable notification of an admin, for example via a user interface now rendering the existing cause event as resolved. Moreover, in this example, where there can be a pending order ticketed for a replacement fan, the correlated cause event being marked as resolved can result in cancelling the order for the replacement fan.

At 832, method 800 can comprise triggering an alteration to the resolution event based on the correlated system alerts. At this point, method 800 can end. Whereas resolution events can be predicated on cause alerts, resolution of a cause alert can be related to altering the resolution event. However, difficulty determining which cause events are resolved can impact the ability to properly alter pending resolution events. Accordingly, the disclosed subject matter can facilitate correlating a clear alert to one or more existing cause alerts, e.g., by identifying related cause alerts in a clear alert. As such, correlated cause alerts can be cleared, e.g., marked as resolved. This can result in altering a pending resolution event. As in the above example, where a cause alert that trigger ordering a replacement fan is correlated to a clear alert indicating that the fan is operating nominally, then the identified and correlated cause alert can be marked as resolved and the order for the replacement fan can be cancelled.

It is yet again noted that a system receiving an alert, such as a cause alert, clear alert, etc., can be independent of a system generating the alert. As such, method 800 can receive and respond to an alert that can be generated by another system, method, etc., e.g., method 700, system 200, 400, etc. However, in some embodiments, method 800 can be practiced in conjunction with another method relating to generating alerts, for example, in system 500, a DMC can generate alerts that an SMC can respond to, etc.

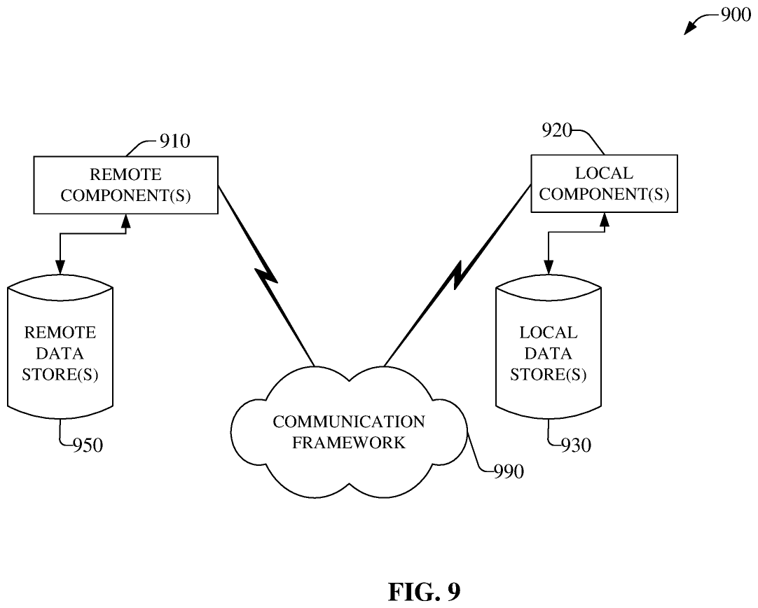

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a remotely located device comprised in SMC 110, 310, 510, etc., DMC 220, 420, 520, 520A-520C, etc., SMCUIC 130, 330, 530, etc., DMCUIC 231, 431, 531, etc., CCRC 160, 360, 560, etc., device 202-206, etc., or other remotely located components connected to a local component via communication framework(s) 990, etc. Communication framework 990 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise a local device comprised in SMC 110, 310, 510, etc., DMC 220, 420, 520, 520A-520C, etc., SMCUIC 130, 330, 530, etc., DMCUIC 231, 431, 531, etc., CCRC 160, 360, 560, etc., device 202-206, etc., or other locally located components.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 990 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 990. Similarly, local component(s) 920 can be operably connected to one or more local data store(s) 930, that can be employed to store information on the local component(s) 920 side of communication framework 990. As an example, DMC 520 can generate and store alerts based on monitoring of devices 502-506, which alerts can be rendered via DMCUIC 531, and which alerts can be communicated via commutation framework 590 to SMC 510 that can store these alerts, for example to facilitate rendering alerts via SMCUIC 530, etc.

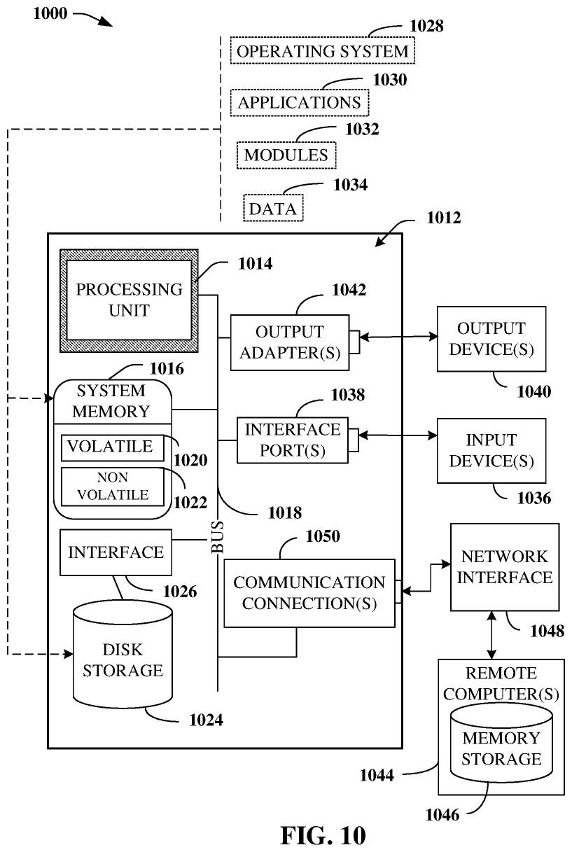

In order to provide a context for the various embodiments of the disclosed subject matter, FIG. 10, and the following discussion, are intended to provide a brief, general description of a suitable environment in which the various embodiments of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random-access memory, synchronous dynamic random-access memory, double data rate synchronous dynamic random-access memory, enhanced synchronous dynamic random-access memory, SynchLink dynamic random-access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, comprised in any of SMC 110, 310, 510, etc., DMC 220, 420, 520, 520A-520C, etc., SMCUIC 130, 330, 530, etc., DMCUIC 231, 431, 531, etc., CCRC 160, 360, 560, etc., device 202-206, etc., or other components disclosed herein, can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random-access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations comprising receiving a first and second cause alert, indicating the first cause alert is correlated to a clear alert based on a cause alert comprised in the clear alert, and enabling access to alerts comprising the first cause alert, the clear alert, and the second cause alert, wherein the first cause alert is distinguishable from the second cause alert based on the first cause alert being correlated to the clear alert.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line-controlled interface, etc., allowing a user to interact with computer 1012. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial bus port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); sixth generation partnership project (6G or 6GPP); other advanced mobile network technologies, third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves and are sometimes referred to extremely high frequency (EHF). The wavelength (λ) for millimeter waves is typically in the 1-mm to 10-mm range.

The term “infer,” or “inference,” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A device monitoring system, comprising:
a processor; and
a memory that stores executable instructions that, when executed by the processor, facilitate performance of operations, comprising:
generating a clear alert based on a change related to a monitored device of devices monitored by the device monitoring system, wherein the clear alert comprises a cause alert identifier related to a cause alert previously generated for the monitored device; and
enabling access to the clear alert, wherein the enabling of the access to the clear alert facilitates correlating, by a system management device, the clear alert to the cause alert, and wherein the enabling of the access to the clear alert facilitates access, via the system management device, to system alert information based on the correlation of the clear alert to the cause alert.

2. The device monitoring system of claim 1, wherein the clear alert is assigned a clear alert identifier that facilitates distinguishing the clear alert from other clear alerts.

3. The device monitoring system of claim 1, wherein the clear alert further comprises a unique device identifier corresponding to the monitored device, and wherein the unique device identifier facilitates identification of the monitored device.

4. The device monitoring system of claim 1, wherein the clear alert further comprises a unique role identifier corresponding to the monitored device, and wherein the unique role identifier facilitates identification of the monitored device based on a role of the monitored device.

5. The device monitoring system of claim 1, wherein the clear alert further comprises an indication of a health of the devices determined after occurrence of the change related to the monitored device.

6. The device monitoring system of claim 1, wherein the change related to the monitored device comprises a variation in performance of hardware of the monitored device.

7. The device monitoring system of claim 1, wherein the change related to the monitored device comprises a variation in performance of software executing via the monitored device.

8. The device monitoring system of claim 1, wherein the change related to the monitored device comprises a variation in an environmental condition of an environment comprising the monitored device.

9. A system management device, comprising:
a processor; and
a memory that stores executable instructions that, when executed by the processor, facilitate performance of operations, comprising:
receiving a clear alert, wherein the clear alert was generated based on a change related to a monitored device of first devices monitored by a first device monitoring system, and wherein the clear alert comprises a cause alert identifier related to a cause alert previously generated for the monitored device;
correlating the clear alert to a first cause alert, resulting in a correlation between the clear alert and the first cause alert, wherein the first cause alert was previously received by the system management device, wherein the correlating is based on the cause alert identifier comprised in the clear alert, and wherein the correlating results in the first cause alert being marked as correlated to the clear alert; and
enabling access to system alerts, wherein the system alerts comprise the first cause alert and a second cause alert that is not marked as correlated to any clear alert, wherein the first cause alert being marked as correlated to the clear alert facilitates distinguishing the first cause alert from the second cause alert.

10. The system management device of claim 9, wherein the enabling of the access to the system alerts enables a ticketing system to modify a previously initiated replacement part order based on the correlation between the first cause alert and the clear alert.

11. The system management device of claim 9, wherein the enabling of the access to the system alerts enables a ticketing system to modify a scheduled service visit schedule based on the correlation between the first cause alert and the clear alert.

12. The system management device of claim 9, wherein the enabling of the access to the system alerts enables a customer service system to initiate contact with an entity affiliated with the monitored device based on the correlation between the first cause alert and the clear alert.

13. The system management device of claim 9, wherein the enabling of the access to the system alerts enables a systems administrator to access a rendered alert log, and wherein the first cause alert is rendered differently from the second cause alert based on the correlation between the first cause alert and the clear alert.

14. The system management device of claim 9, wherein the enabling of the access to the system alerts enables a systems administrator to access a rendered alert log, wherein the second cause alert is rendered, and wherein the first cause alert is not rendered based on the correlation between the first cause alert and the clear alert.

15. A non-transitory machine-readable storage medium, comprising executable instructions that, when executed by a processor, facilitate performance of operations, comprising:
receiving a first cause alert, wherein the first cause alert was generated based on a first change related to a monitored device of first devices monitored by a first device monitoring system;
receiving a clear alert, wherein the clear alert was generated based on a second change related to the monitored device of first devices monitored by the first device monitoring system, and wherein the clear alert comprises a cause alert identifier related to the first cause alert;
indicating that the first cause alert is correlated to the clear alert based on the cause alert identifier being employed to determine a correlation between the first cause alert and the clear alert; and
enabling access to alerts comprising the first cause alert, the clear alert, and a second cause alert, wherein the second cause alert is not indicated as correlated to any clear alert, and wherein the enabling of the access to the alerts facilitates distinguishing the first cause alert from the second cause alert based on the indicating that the first cause alert is correlated to the clear alert.

16. The non-transitory machine-readable storage medium of claim 15, wherein the receiving the first cause alert corresponds to the first change being a hardware performance change of hardware comprised by the monitored device.

17. The non-transitory machine-readable storage medium of claim 15, wherein the receiving the first cause alert corresponds to the first change being a software performance change of software supported by the monitored device.

18. The non-transitory machine-readable storage medium of claim 15, wherein the receiving the first cause alert corresponds to the first change relating to an environment experienced by the monitored device.

19. The non-transitory machine-readable medium of claim 15, wherein the enabling of the access to the alerts enables rendering the first cause alert in an alert log, based on the correlation between the first cause alert and the clear alert, differently from rendering the second cause alert in the alert log.

20. The non-transitory machine-readable medium of claim 15, wherein the enabling of the access to the alerts enables rendering the second cause alert in an alert log and not rendering the first cause alert in the alert log based on the correlation between the first cause alert and the clear alert.
